(19) United States
(12) Patent Application Publication
(10) Pub. No.: US 2006/0195792 A1
(43) Pub. Date: Aug. 31, 2006

(54) SYSTEM AND METHOD FOR AUDIO/VIDEO EQUIPMENT AND DISPLAY SELECTION AND LAYOUT THEREOF

(75) Inventors: William Robert Burnett, Menlo Park, CA (US); Joseph Marc McConnaughey, Chino Hills, CA (US); Michael O'Connor, Cupertino, CA (US)

Correspondence Address: SQUIRE, SANDERS & DEMPSEY L.L.P, 600 HANSEN WAY, PALO ALTO, CA, 94304-1043, US

(73) Assignee: NLIGHTEN TECHNOLOGIES, Mountain View, CA (US)

(21) Appl. No.: 10/906,612

(22) Filed: Feb. 26, 2005

(51) Int. Cl. G06F 17/00

(52) U.S. Cl. 715/745

(57) ABSTRACT

A system and method enable to the optimized selection and layout of a display and related components based on customer preferences, light sources, room dimensions, viewing distance and other factors. The system and method also enable the interior design of the room in which the display will be situated based on the above factors and other factors.

### TECHNICAL FIELD

This invention relates generally to display equipment, and particularly, but not exclusively, provides a system and method for home theater design, including selecting audio/video (AV) equipment and a display and the layout thereof.

### BACKGROUND

The conventional process for purchasing a large screen display system for the home, office, or elsewhere is difficult and entails purchase, transport and installation by the customer, often with poor results. Many issues can cause problems with the installation such as poor placement of the display in the environment exposing it to excessive stray light from windows, poor matching of the display type, size, and user viewing positions for the intended environment. In addition, multiple input signals to these displays are common; terrestrial antenna signals, cable, satellite, DVD, and VHS players being among the most popular. Further compounding the confusion, each of these input signals can have an analog and a digital version. If the display system is not properly configured when installed or if interconnected incorrectly it will not be able to receive the input signal clearly. This can cause a degraded image or a failure to function. Further, the display may not be a good aesthetic match to its environment.

Because of the complexity of the above installation, some customers hire professional video system installers in order to develop a design that better matches their home or office and provides them with the display fidelity that they desire. These professional video installers are then responsible for the proper installation of the system. While this approach solves some of the design and interconnection problems, this is a long and expensive process that does not provide optimal results.

Accordingly, a new system and method are needed that overcome the above mentioned deficiencies in a cost and time efficient manner.

### SUMMARY

Embodiments of the invention enable a customer to quickly and easily select the size and position of a display, pre-approve, order, and receive delivery of large displays for installation in the home, office, or other location. Embodiments use a web-based process for assessing the customer's needs, using an interactive expert system for making trade-offs in the display size and features, providing the customer with visualizations of the proffered designs, and completing the process by delivery and installation of the actual product, thereby enabling the delivery of custom designed displays that have been pre-approved optimized to fit their intended environment.

In an embodiment of the invention, the method comprises: receiving customer information; optimizing display characteristics based on the customer information; and selecting a display based on the optimized display characteristics.

In an embodiment of the invention, the system comprises: a graphical user interface, a theater engine, and a component engine. The graphical user interface receives customer information. The theater engine, which is communicatively coupled to the graphical user interface, optimizes the display characteristics based on the customer information. The component engine, which is communicatively coupled to the theater engine, selects a display based on the optimized display characteristics.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system in accordance with an embodiment of the present invention;

FIG. 2 is a block diagram illustrating a computer capable of hosting one of the nodes of the network system 100;

FIG. 3 is a block diagram illustrating the display system of FIG. 1;

FIG. 4 is a block diagram illustrating the order engine of the display system of FIG. 1;

FIG. 5 is a flowchart illustrating a method of ordering and laying out a display system;

FIG. 6 is a flowchart illustrating a method of receiving customer data;

FIG. 7 is a flowchart illustrating a method of optimizing the layout design;

FIG. 8 is a flowchart illustrating a method of optimizing the electronic design;

FIG. 9 is a flowchart illustrating a method of optimizing the interior design;

FIG. 10 is a flowchart illustrating a method of visualizing the combined optimized layout, electronic and interior designs;

FIG. 11 is a flowchart illustrating a method of pricing; and

FIG. 12 is a flowchart illustrating a method of scheduling.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

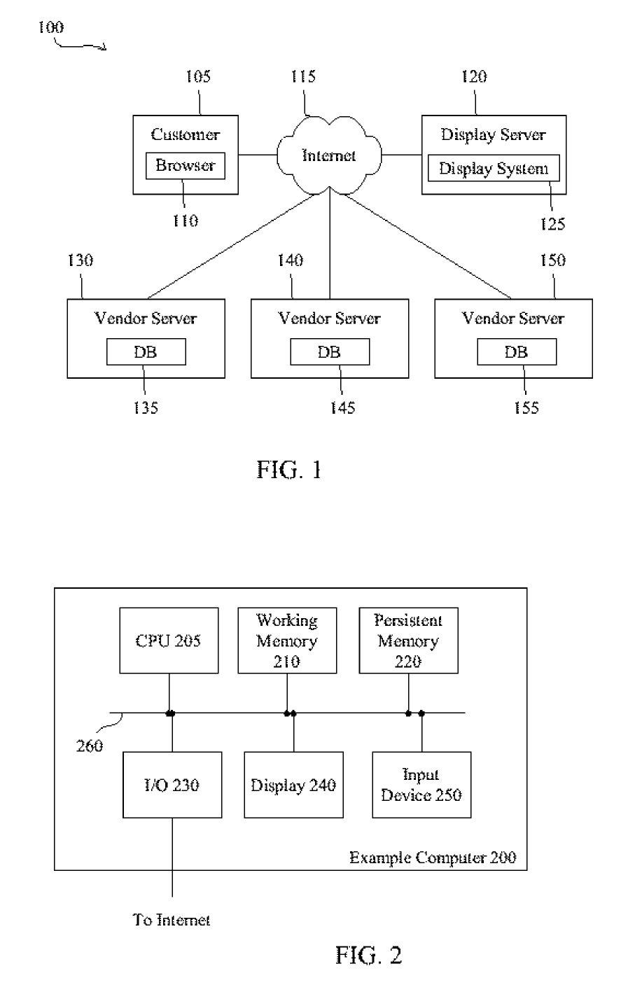

FIG. 1 is a block diagram illustrating a network system 100 in accordance with an embodiment of the present invention. The network system 100 comprises a customer computer 105 hosting a browser 110, such as Internet Explorer or Firefox. The customer 105 is communicatively coupled to the Internet 115 or other network, which is communicatively coupled to a plurality of servers including a display server 120 and vendor servers 130, 140, and 150. The display server 120 hosts a display system 125 and the vendor servers 130, 140, and 150 each host a database (i.e., databases 135, 145, and 155, respectively). It will be appreciated by one of ordinary skill in the art that the network system 100 can include additional nodes, such as additional vendor servers and customers. However, for the sake of clarity, only one customer and three vendor servers are shown. Further, it will be appreciated by one of ordinary skill in the art that the Internet 115 is optional and the network nodes can be communicatively coupled directly to each other. In another embodiment of the invention, the browser 110, the display system 125, and the databases 135, 145, and 155 can be resident on a single network node or be distributed in any other matter.

The browser 110 communicates with the display system 125 via the Internet 115. Specifically, the browser 110 receives a graphical user interface (GUI) in HTML and/or other code from the display system 125 and uses the GUI to transmit customer information and requirements to the display system 125 for processing. The display system 125, as will be discussed further below, uses the customer information and requirements, in conjunction with the databases 135, 145, and 155, to optimize AV equipment, layout, and interior design. The databases 135, 145, and 155 can each hold data on components and their pricing used in the electronic design (e.g., displays, DVD/CD players, satellite TV receivers, audio amplifiers, cables, speakers, etc.) and/or the interior design (e.g., display cabinets and/or other furniture).

FIG. 2 is a block diagram illustrating an example computer 200 that is capable hosting a node of the network system 100 (FIG. 1). The example computer 200 includes a central processing unit (CPU) 205; working memory 210; persistent memory 220; input/output (I/O) interface 230; display 240; and input device 250, all communicatively coupled to each other via a bus 260. The CPU 205 may include an INTEL PENTIUM microprocessor, a Motorola POWERPC microprocessor, or any other processor capable to execute software (e.g., the display system 125) stored in the persistent memory 220. The working memory 210 may include random access memory (RAM) or any other type of read/write memory devices or combination of memory devices. The persistent memory 220 may include a hard drive, read only memory (ROM) or any other type of memory device or combination of memory devices that can retain data after the example computer 200 is shut off. The I/O interface 230 is communicatively coupled, via wired or wireless techniques, to the Internet 115. The display 240 may include a flat panel display, cathode ray tube display, or any other display device. The input device 250, which is optional like other components of the invention, may include a keyboard, mouse, or other device for inputting data, or a combination of devices for inputting data.

One skilled in the art will recognize that the example computer 200 may also include additional devices, such as network connections, additional memory, additional processors, LANs, input/output lines for transferring information across a hardware channel, the Internet or an intranet, etc. One skilled in the art will also recognize that the programs and data may be received by and stored in the system in alternative ways. Further, in an embodiment of the invention, an ASIC is used in placed of the computer 200 to perform the functions of the display system 125.

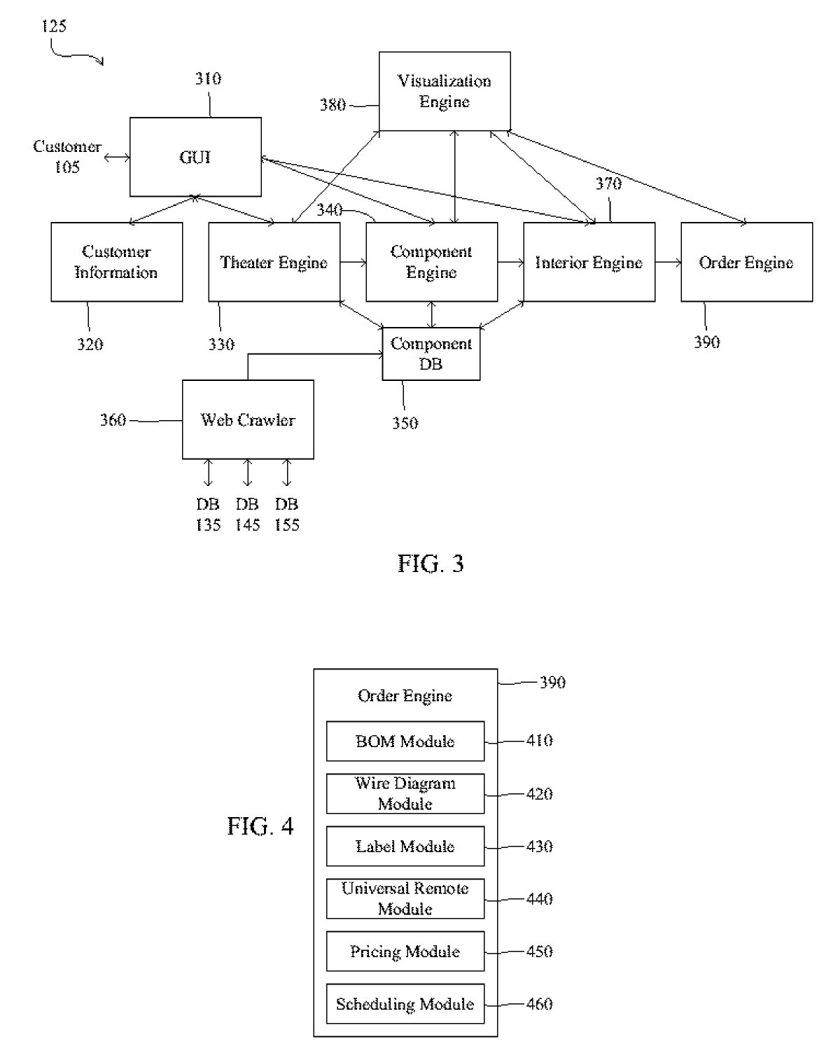

FIG. 3 is a block diagram illustrating the display system 125 (FIG. 1). The display system 125 includes a GUI 310, a theater engine 330, a component engine 340, a component database 350, a web crawler 360, an interior engine 370, a visualization engine 380, and an order engine 390. The GUI 310 communicates with the browser 110 to receive customer information 320, such as the current position of the display in his/her room, the size of the wall against which the display will be situated, other room dimensions, carpet or floor information, the locations of windows and other light sources, the direction to which the windows open, the location and height of the viewer (e.g., customer) in the room, the display resolution desired, the display size desired, the interior design of the room (e.g., current furniture layout, fabric, decor, flooring, etc.), preferred furniture style (e.g., colonial or modern), the variety and type of inputs (e.g., high definition, analog or digital), any additional features, the total maximum price acceptable to the customer, the address of the customer, current AV equipment and furniture (and their locations) and other information. The GUI 310 also communicates with the other engines to display optimization results to the browser 110, as will be discussed further below.

The theater engine 330, using the customer information 320 and the database 350, determines seating layout, viewing distances and angles, and display characteristics, such as the optimal display size, resolution, contrast, and brightness based on the distances and angles between the display and viewing positions as described in: Izenour, George C., Theater Design, Second Edition, Ham, Roderick, Theaters, Planning guidance for design and adaptation, Architectural Press 1987, Ramsey, Charles, Architectural Graphic Standards, Vol. 9, John Wiley & Sons 1998, Bass, Michael, et. Al, Handbook of Optics, V1-4, Optical Society of America 1997, determines the effect of light sources based on window location, directions the windows open to and location of the house and the location of other light sources in the room; determines the optimal viewing area based on viewing distance constraints and available wall or shelf space; and determines layout of a sound system as described in: Ballou, Glen, Ed., Handbook for Sound Engineers, 2nd ed, Howard Sams, Carmel, Ind., 1991, Davis, Carolyn, Sound System Engineering, Focal Press, 1997, Dickason, Vance, Cananaugh, J. Wilkes, Architectural Acoustics : Principles and Practice, Wiley 1999, The Master Handbook of Acoustics, 3rd ed., Tab Books, New York, 1994.

The theater engine 340 optimizes selection and/or configuration of display features including screen type, display type, and screen coatings to compensate for glare from ambient light sources such as windows, doors, and overhead lighting. After the optimization is completed, the theater engine 330 presents its results to the customer 105 via the GUI 310 to enable the customer 105 to modify the layout or to relax or change constraints to yield a different layout. The results can include a single optimization or a plurality of optimizations for selection by the customer 105.

After the theater engine's 330 optimization is complete and approved by the customer 105, the component engine 340 accesses the database 350 to retrieve component specifications (e.g., electronic specifications and/or price) for the customer's 105 current AV equipment and display and for new or additional AV equipment and displays that match the optimizations determined by the theater engine 330 (e.g., display size and resolution, screen type, screen coatings anti-reflective or anti-glare). In an embodiment of the invention, the component engine optimization of AV equipment and display is also based on the number and type of inputs (e.g., high definition, analog and/or digital signals). In an embodiment of the invention, based on the customer address specified in the customer information 320, the AV equipment and displays accessed in the database can be limited to those available within, and compatible with the broadcast and power distribution standards of a specific geographic region (e.g., the country in which the customer resides). The component engine 340 then optimizes the AV equipment and display selection based on the retrieved specifications, the layout constraints determined by the theater engine 330, and the price constraints listed in the customer information 320. The optimization can include the customer's 105 prior AV equipment and display as well new or additional AV equipment or displays. The optimization can then be displayed to the customer 105 via the GUI 310. In an embodiment of the invention, a plurality of possible optimized AV equipment and display combinations can be shown to the customer via the GUI 310 for the customer 105 to select based on weighting certain constraints higher than others. The weighting can be done based on customer 105 preferences or by weighting one or more constraints differently in each combination. For example, in one combination, resolution can be weighted highest while in another, audio quality can weighted highest. In an embodiment the weightings that are applied (in highest to lowest order) are customer budget, display size & resolution, highest image quality (generally requiring that video be processed digitally by all video components), audio quality, simple human interface control of AV equipment (generally requiring more equipment from a single manufacturer and fewer components), components from desired brand names list, and physical dimensions of display and AV components. The weighting can be done using a linear or non-linear (e.g., exponential) weighting algorithm.

After the component selection is complete and approved by the customer 105, the interior engine 370 accesses the database 350 and uses the customer information 320 to perform an interior layout optimization. This optimization includes optimizing cabinetry for the selected components, including cabinets, racks, stacks, faceplates, bezels, and/or mounting equipment, etc. by optimizing finishes for the selected components so that all components are aesthetically pleasing with respect to each other and the current furnishings in the room (e.g., same finish for all components and furniture) and/or adding furniture such as display stands or cabinets, if needed. In an embodiment of the invention, the optimization also includes surface finishes, colors and textures, fabric types, and room décor, etc., as described in: De Wolfe, Elise, The House In Good Taste, Guild, Tricia, Think Color: Rooms To Live In, Gill, Martha, Color Harmony for Interior Design, Zelnick, Martin, Timesaver Standards for Interior Design and Space Planning, 2^{nd} Edition, Home Theater Design, Planning & Decorating Media Savvy Interiors, Krissy Rushing, Kalomarikas, Leo, Great Escapes: New Designs for Home Theaters. The optimization is then displayed to the customer 105 via the GUI 310 for approval or modification. In an embodiment of the invention, multiple optimizations can be displayed for a selection by the customer 105. Further, the customer can modify a proposed optimization according to his or her tastes (e.g., by modifying furniture style).

After the interior engine 370 has completed the optimization and it has been approved by the customer 105, the visualization engine 380 combines the optimizations from the theater engine 330, the selections from the component engine 340 and design from the interior engine 370 and uses the GUI 310 to display the combined optimizations, selections, and design for the customer's final review and modification. Once approved, the order engine 390 generates the order including optimizing pricing, generating a bill of materials (and ordering the components listed therein from vendors), generating a wiring diagram, generating labels for placement on component packaging, generates instructions for programming a universal remote, and develops a schedule for delivery and installation. The functioning of the order engine 390 will be discussed in further detail below.

The component database 350 includes data on electronic components from a plurality of vendor databases, such as the vendor databases 135, 145, and 155. The data can include component dimensions, display resolution, display screen size, screen type and coatings, audio specifications, pricing, available finishes, geographic availability, and other data. In an embodiment of the invention, the component database 350 can also include information on furnishings for use with the components (e.g., display stands or cabinets). One of ordinary skill in the art will recognize that the database 350 can be separated into multiple databases or comprise a single database as shown.

The web crawler 360 regularly searches vendor databases 135, 145, and 155 for component information and updates the component database 350 accordingly. The web crawler 360 can perform the searches and updates the database 350 during slow business times (e.g., early morning hours) so as to limit disruption to the component database 350 to non-peak ordering hours. In an embodiment of the invention, the web crawler 360 can perform searches of vendor databases 135, 145, and 155 whenever a customer uses the display system 125. This will ensure that only the most current information is provided to the customer 105 but may slow down the optimization processes.

In an embodiment of the invention, the display system 125 includes additional databases, such as a database for storing the customer information 320 and optimizations performed and/or approved for and by the customer so that the customer can later access the optimizations for later modification or approval. Further, the database may include ordered systems, supporting warranty information and other information to aid in the repair and/or upgrading of the system.

FIG. 4 is a block diagram illustrating the order engine 390 of the display system 125. The order engine comprises a Bill of Materials (BOM) module 410, a wire diagram module 420, a label module 430, a universal remote module 440 and a pricing module 450. The BOM module 410 generates a list of components approved by the customer for purchase as well as all cabling, hardware and other equipment needed for installation. The wire diagram module 420 assembles instructions for placement of the components and communicatively coupling the components (via wired and/or wireless techniques, such as Ultra Wideband) to optimize audio and video output. The label module 430 generates labels for all component packaging to correlate with the wiring instructions generated by the wire diagram module 420 so that the installer can easily install the equipment. The universal remote module 440 programs a universal remote control to work with all components in the BOM generated by the BOM module 410 as well as/or any current customer components that will be used in the installation.

The pricing module 450 optimizes pricing for all components listed in the BOM including wiring and other items necessary for installation. In an embodiment of the invention, the pricing module 450 optimizes pricing by searching various vendor databases to identify the lowest cost for each component. In an embodiment of the invention, the pricing module 450 also adds in the cost of installation itself and shipping. After optimizing pricing, the pricing module 450 in conjunction with the GUI 310, present the optimized pricing to the customer 105 for modification (e.g., ordering from different vendors), approval, and payment.

Once payment information is received and validated, the scheduling module 460 orders the components listed in the BOM from vendor(s) and then schedules customer installation based on the customer's preferences, installer availability, and the expected arrival date from vendor(s) of all components.

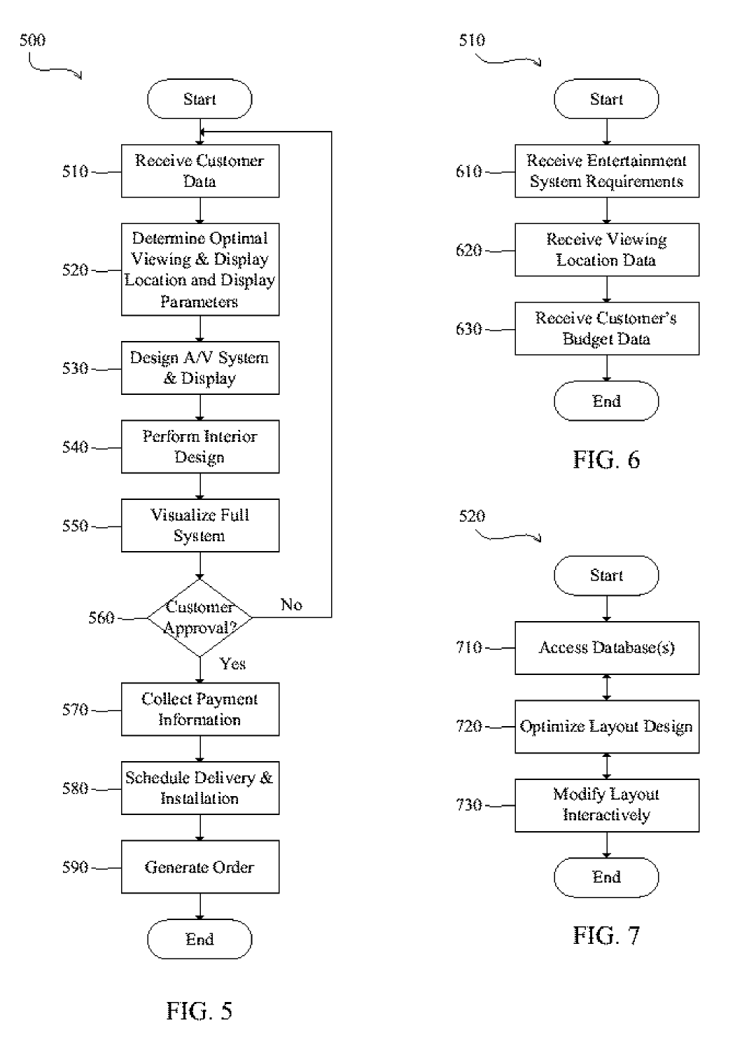

FIG. 5 is a flowchart illustrating a method 500 of ordering and laying out a display system. In an embodiment of the invention, the display system 125 executes the method 500. Further, the display system 125 can execute multiple instances of the method 500 substantially simultaneously for a plurality of customers and/or for a single customer (e.g., for multiple rooms of a single customer). Further, the sequences described below can be executed in an order other than that described.

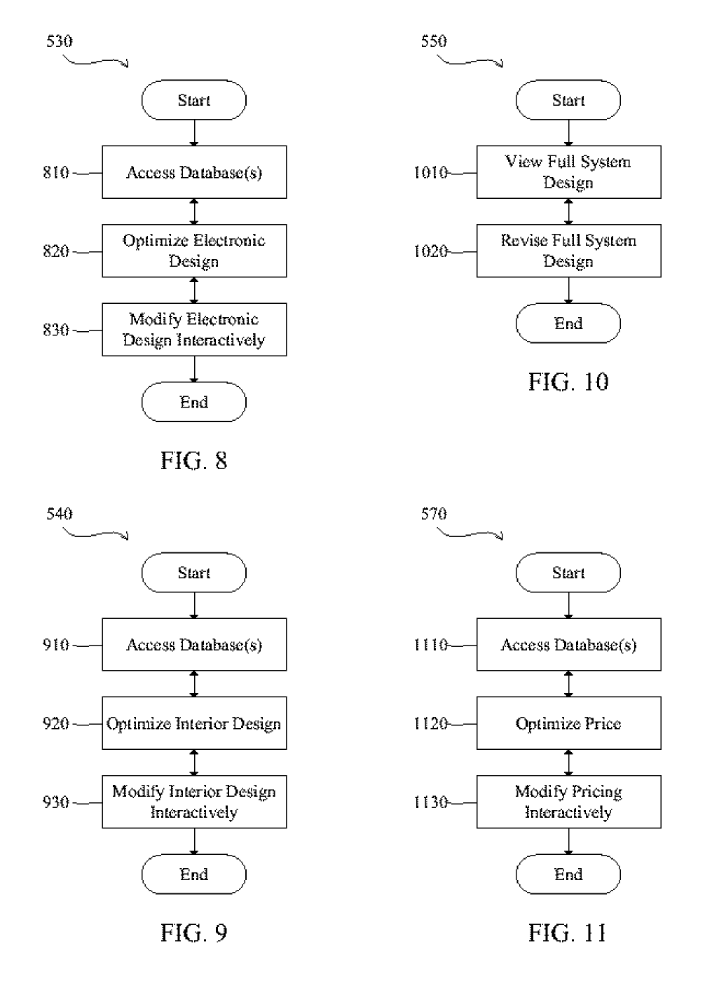

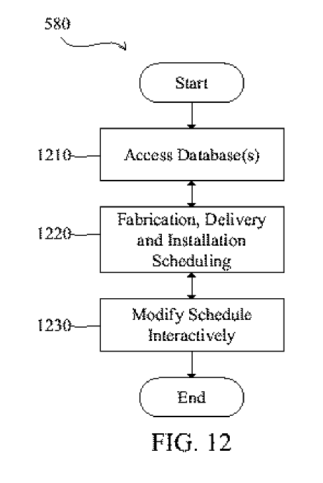

First, customer data is received (510) as will be discussed in further detail in conjunction with FIG. 6. Based on the received (510) customer information, the display parameters and optimal viewing and display locations are determined (520) as will be discussed in further detail in conjunction with FIG. 7. The audio (e.g., speakers)/video (e.g., DVD player) equipment is then designed (530) along with the display itself according to the determined (520) display parameters, as will be discussed in further detail in conjunction with FIG. 8. Interior design is then performed (540), as will be discussed in further detail in conjunction with FIG. 9. The full system is then visualized (550) including all the designed A/V equipment and display, viewing location and display location and interior design, as will be discussed in further detail in conjunction with FIG. 10. Once approved (560) by the customer, payment information is collected (570) as will be discussed in further detail in conjunction with FIG. 11 and delivery and installation is scheduled (580) as will be discussed in further detail in conjunction with FIG. 12. The order is then generated (590) including generating wiring instructions for communicatively coupling components together, generating labels for the component packaging based on the wiring instructions, and programming a universal remote control to work with all ordered components and current customer components that will be used in the installation. The method 500 then ends.

FIG. 6 is a flowchart illustrating a method 510 of receiving customer data. First, entertainment system requirements are received (610), such as display size and resolution and the variety and type of inputs (e.g., high definition, analog or digital). Viewing location and display location data are then received (620). The customer's budget data is then received (630) such as maximum price willing to pay and/or the apportionment between different components (e.g., 80% display, 20% sound). The method 510 then ends. In an embodiment of the invention, other data received (510) can include: the size of the wall against which the display will be situated, other room dimensions, carpet or floor information, the locations of windows and other light sources, the direction to which the windows open, the interior design of the room (e.g., current furniture layout, fabric, decor, flooring, etc.), preferred furniture style, any additional features, the address of the customer, current AV equipment and furniture (and their locations) and other information.

FIG. 7 is a flowchart illustrating a method 520 of optimizing layout design. First, a database, such as the component database 350, is accessed (710). The accessing (710) retrieves display size and resolution information as a function of viewing distance as well as the effect of light rays throughout the year from windows as a function of window orientation and address. The layout design is then optimized (720) to determine the placement of the display to minimize the amount of light impacting the display, the placement of the viewer, and the display resolution and size based on the distance between the display and the viewer and the wall size or shelf size. In an embodiment of the invention, the sound system layout can also be optimized based on placement of the display and location of the viewer. The layout is then modified (730) interactively with the customer to relax or strengthen constraints used in the optimization process and a new layout design can then be optimized (720) based on the modified constraints. Once modification (730) is complete, the method 520 ends.

FIG. 8 is a flowchart illustrating a method 530 of optimizing the selection of AV components and their interconnections. First, a database, such as the database 350, is accessed (810) to retrieve AV components matching the profile determined in the layout optimization (720), and the customer information 320 is accessed to identify currently owned AV components that the customer desires to use. The retrieved components are then optimized (820) to determine the electronic design combination providing the highest video and audio fidelity consistent with the customer's desired cost and AV system performance. The electronic design is then modified (830) interactively by weighting certain factors higher or lower per the customer's preferences. For example, display resolution can be weighted lower while display size can be weighted higher. The electronic design is then optimized (820) according to the revised constraints. The method 530 then ends.

FIG. 9 is a flowchart illustrating a method 540 of optimizing the interior design. After the electronic design optimization (820) is complete, the interior design is optimized. First, a database, such as the database 350, is accessed (910) to retrieve finishes available for the electronic design components selected. Then, using the customer information 320 (e.g., design preferences, furniture style preferences, etc.) to perform an interior layout optimization (920). This optimization includes optimizing finishes for the selected components so that all components are aesthetically pleasing with respect to each other and the current furnishings in the room (e.g., same finish for all components and furniture). In addition, the interior layout optimization (920) can include adding furniture such as display cabinets, if needed. In an embodiment of the invention, the optimization (920) also includes surface finishes, colors and textures, fabric types, and room decor, etc. After the optimization (920), the interior design can be interactively modified (930) by the customer by relaxing or strengthening constraints (e.g., finishes matching, color coordination, furniture styles, etc.) and the optimization (920) performed again based on the revised constraints. The method 540 then ends.

FIG. 10 is a flowchart illustrating a method 550 of visualizing the combined optimized layout, electronic and interior designs. First, the optimizations (720, 820, and 920) are combined into a single visualization (1010) and displayed to the customer. Then the combined system can be revised (1020) and visualized (1010) again. The method 550 then ends.

FIG. 11 is a flowchart illustrating a method 570 of pricing. First, a database, such as the database 350, is accessed (1110) to retrieve pricing information for the electronic components optimized (820). Pricing can be from a plurality of vendors for each component so that the lowest price is retrieved. Further, pricing can include shipping costs based on distance between the vendor and customer. The pricing can also be limited to vendors within a certain geographic area (e.g., same country as the customer). The pricing is then optimized (1120) by combining the lowest prices for each component taking into account shipping costs, if any. Pricing can then be interactively modified (1130) by the customer to select different vendors or constraints, such as personal preferences, shipping time, reliability, etc. and the price optimized (1120) again. The method 570 then ends.

FIG. 12 is a flowchart illustrating a method 580 of scheduling. First, a database, such as the database 350, is accessed (1210) to retrieve component availability, shipping times, fabrication times (if any) and installer availability. Then fabrication, delivery and installation is scheduled (1220) based on the retrieved information and customer preferences. The schedule is then modified (1230) interactively based on customer preferences. The method 580 then ends. In an embodiment of the invention, once scheduling is complete, the components can be ordered, a wire diagram generated, labels for component packaging generated, and a universal remote programmed.

The foregoing description of the illustrated embodiments of the present invention is by way of example only, and other variations and modifications of the above-described embodiments and methods are possible in light of the foregoing teaching. For example, instead of ordering a manufactured display from a vendor, the display can be manufactured per optimization by the theater engine 330 (e.g., if a display is not manufactured per the optimization), i.e., the display can be made to match the room instead of modifying the room to match the display. Further, interactive modifications of optimizations can be done by moving or changing specific components or items instead of modifying constraints used in the optimization. In addition, the optimizations, layouts, interior designs, etc. described above can be used for any area requiring a display, such as offices, theaters, restaurants, bars, etc. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A computer-based method, comprising:
receiving customer information;
optimizing display characteristics based on the customer information; and
selecting a display based on the optimized display characteristics.

2. The method of claim 1, wherein the customer information includes room dimensions, and wherein the method further comprising optimizing a display position and a viewer position.

3. The method of claim 2, further comprising optimizing the position of an audio system based on the optimized display and viewer positions.

4. The method of claim 1, wherein the customer information includes light sources, and wherein the method further comprises optimizing the position of the display to minimize light reflecting off of the display to the viewer.

5. The method of claim 1, wherein the optimizing the display characteristics includes selecting display type, screen type, resolution, screen coatings and screen diagonal.

6. The method of claim 1, further comprising matching the display design to the interior design of a room in which the display will be situated based on the customer information.

7. The method of claim 1, further comprising:
optimizing a display position and a viewer position;
optimizing the position of an audio system based on the optimized display and viewer positions;
matching the display and audio system design to the interior design of a room in which the display will be situated based on the customer information; and
transmitting a visualization to the customer incorporating the optimized display position, viewer position, audio system position, and interior design.

8. The method of claim 1, wherein selecting a display includes manufacturing a display if a manufactured display does not meet the optimized or customer desired display characteristics.

9. The method of claim 1, further comprising programming a remote control to control a plurality of electronic devices based on the selecting and devices specified in the customer information or additional devices selected.

10. The method of claim 1, further comprising:
generating a wiring diagram to connect components; and
generating labels for component packaging corresponding to the wiring diagram.

11. A system, comprising:
a graphical user interface capable of receiving customer information;
a theater engine, communicatively coupled to the graphical user interface, capable of optimizing display characteristics based on the customer information; and
a component engine, communicatively coupled to the theater engine, capable of selecting a display based on the optimized display characteristics.

12. The system of claim 11, wherein the theater engine is further capable of optimizing room layout characteristics based on the customer information.

13. The system of claim 11, wherein the customer information includes room dimensions, and wherein the theater engine is further capable of optimizing a display position and a viewer position.

14. The system of claim 13, wherein the theater engine is further capable of optimizing the position of an audio system based on the optimized display and viewer positions.

15. The system of claim 11, wherein the customer information includes light sources, and wherein the theater engine is further capable of optimizing the position of the display to minimize light reflecting off of the display to the viewer.

16. The system of claim 11, wherein the theater engine's capability of optimizing the display characteristics includes the capability of selecting display type, screen type, screen diagonal and screen coatings.

17. The system of claim 11, further comprising an interior engine, communicatively coupled to the graphical user interface and the component engine, capable of matching the display cabinetry and the interior of a room in which the display will be situated based on the customer information.

18. The system of claim 11, wherein the theater engine is capable of optimizing a display position and a viewer position and optimizing the position of an audio system based on the optimized display and viewer positions;
and wherein the system further comprises:
an interior engine, communicatively coupled to the graphical user interface and the component engine, capable of matching the display cabinetry and the interior of a room in which the display will be situated based on the customer information; and
a visualization engine, communicatively coupled to the component engine, the theater engine and the interior engine, capable of transmitting a visualization to the customer incorporating the optimized display position, audio system position, viewer position, optimized cabinetry design, and system interconnects schematics.

19. The system of claim 11, wherein the component engine is further capable of optimizing equipment selection and interconnects.

20. The system of claim 11, further comprising an order engine capable of ordering the manufacture of a display if a manufactured display does not meet the optimized display characteristics.

21. The system of claim 11, further comprising a universal remote module, communicatively coupled to the component engine, capable of programming a remote control to control a plurality of electronic devices based on the selected display and devices specified in the customer information or additional devices selected.

22. The system of claim 11, further comprising:
a wire diagram module, communicatively coupled to the component engine, capable of generating a wiring diagram and instructions to connect components; and
a label module, communicatively coupled to the wire diagram module, capable of generating labels for component packaging corresponding to the wiring diagram.

23. The system of claim 11, further comprising:
a pricing module, communicatively coupled to the component engine, capable of optimizing pricing and accepting payment; and
a scheduling module, communicatively coupled to the pricing module, capable of scheduling delivery and installation.

24. A system, comprising:
means for receiving customer information;
means for optimizing display characteristics based on the customer information; and
means for selecting a display based on the optimized display characteristics.

25. A computer-readable medium having stored thereon instructions to cause a computer to execute a method, the method comprising:
receiving customer information;
optimizing display characteristics based on the customer information; and
selecting a display based on the optimized display characteristics.
